(19) United States
(12) Patent Application Publication
(10) Pub. No.: US 2017/0345073 A1
(43) Pub. Date: Nov. 30, 2017

(54) ELECTRONIC NOTIFICATIONS TO FACILITATE COLLATERALIZED AGREEMENTS

(71) Applicant: Spotchu, LLC, Rexburg, ID (US)

(72) Inventors: David Bryan Ferre, Pleasant Grove, UT (US); Brian Kent Ball, Rexburg, ID (US); Michael Jonathan Hattersley, Bryn Mawr, PA (US)

(21) Appl. No.: 15/602,344

(22) Filed: May 23, 2017

Related U.S. Application Data
(60) Provisional application No. 62/340,892, filed on May 24, 2016.

(51) Int. Cl. G06Q 30/06; H04L 29/08; G06F 7/02

(52) U.S. Cl. CPC G06Q 30/0611; G06F 7/026; H04L 67/26

(57) ABSTRACT

Interactive electronic push notifications are utilized to remotely facilitate collateralized arrangements. An identifier of an article that is being offered as collateral is received from a first computer system. A unique identifier and a score associated with a first user is accessed. The article identifier is matched against a second database to identify a second computer system that has subscribed to notifications associated with the article identifier. An electronic notification is generated for the second computer system that includes the article identifier, the unique identifier, and the score. An offer for an amount of a collateralized against the article associated with the article identifier is received from the second computer system. The offer received from the second computer system is sent to the first computer system. A response is received from the first computer system associated with the offer from the second computer system.

### CROSS-REFERENCE TO RELATED APPLICATION

This application claims priority to and the benefit of U.S. Provisional Patent Application No. 62/340,892 filed May 24, 2016, entitled “Interactive Push Notifications to Execute Collateralized Loan Agreements,” which is incorporated herein by reference in its entirety.

### BACKGROUND

Computing systems are commonly used to facilitate transactions between individuals. Computer systems have also been adapted for use by entities to post goods or services that interested parties can find and pursue. This may be done online through websites, or by providing an online storefront. However, such online solutions often introduce inefficiencies, both in terms of human efforts and use of computing resources. For example, computing systems hosting online storefronts must process and respond to a great number of query requests as computing systems of interested parties query for available goods. Additionally, computing systems of interested parties must initiate search queries against the computing systems hosting the storefronts, each time an interested party desires to check for availability of particular goods or services. These repeated search requests inefficiently use both computer processing resources and computer network resources.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to utilizing interactive electronic push notifications to remotely facilitate collateralized arrangements backed by physical articles. For example, embodiments may include receiving, from a first computer system, an identifier of a physical article that is being presented as collateral. In response to receiving the article identifier, a number of actions may be performed. For instance, embodiments may include accessing both a unique identifier and a score associated with a first user possessing the article. Embodiments may also include storing the article identifier, the unique identifier associated with the first user, and the score associated with the first user, in a first database.

Embodiments may further include matching the stored article identifier against a second database to identify at least a second computer system that has subscribed to notifications associated with the stored article identifier. In response to identifying the second computer system, an electronic notification may be generated for the second computer system that includes the article identifier, the unique identifier associated with the first user, and the score associated with the first user. Embodiments may also include receiving, from the second computer system, an offer against the article associated with the article identifier. In response to receiving the offer from the second computer system, the offer received from the second computer system may be sent to the first computer system. Embodiments may also include receiving a response from the first computer system associated with the offer from the second computer system.

In this way, a computing platform allows for directly connecting first users having items to offer as collateral with second users who are willing to provide resources against the items of collateral (and to take possession of the collateral, should the first user fail to meet collateralized agreement obligations). The social computing platform described herein employs unique subscription mechanisms to enable computer systems to subscribe to receive electronic notifications of the availability of particular goods or types of goods, and unique electronic notification mechanisms to notify these computer systems when a user seeks resources against a subscribed-to good. Doing so achieves improved computing efficiency over implementing existing online storefronts, by at least eliminating a great number of search queries associated with users querying for the availability of goods.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates a flow chart of an example method for remotely facilitating collateralized arrangements.

FIG. 3 illustrates a flow chart of an example method for determining a score for a user; and

FIGS. 4A and 4B illustrate exemplary interactive visual electronic notifications displayed at a computing device.

### DETAILED DESCRIPTION

At least some embodiments described herein relate to utilizing interactive electronic push notifications to remotely facilitate collateralized arrangements backed by physical articles. For example, embodiments may include receiving, from a first computer system, an identifier of a physical article that is being presented as collateral. In response to receiving the article identifier, a number of actions may be performed. For instance, embodiments may include accessing both a unique identifier and a score associated with a first user possessing the article. Embodiments may also include storing the article identifier, the unique identifier associated with the first user, and the score associated with the first user, in a first database.

Embodiments may further include matching the stored article identifier against a second database to identify at least a second computer system that has subscribed to notifications associated with the stored article identifier. In response to identifying the second computer system, an electronic notification may be generated for the second computer system that includes the article identifier, the unique identifier associated with the first user, and the score associated with the first user. Embodiments may also include receiving, from the second computer system, an offer against the article associated with the article identifier. In response to receiving the offer from the second computer system, the offer received from the second computer system may be sent to the first computer system. Embodiments may also include receiving a response from the first computer system associated with the offer from the second computer system.

In this way, a computing platform allows for directly connecting first users having items to offer as collateral with second users who are willing to provide resources against the items of collateral (and to take possession of the collateral, should the first user fail to meet collateralized agreement obligations). The computing platform described herein employs unique subscription mechanisms to enable computer systems to subscribe to receive electronic notifications of the availability of particular goods or types of goods, and unique electronic notification mechanisms to notify these computer systems when a user seeks resources against a subscribed-to good. Doing so achieves improved computing efficiency over implementing existing online storefronts, by at least eliminating a great number of search queries associated with users querying for the availability of goods.

In some embodiments, a transaction is initiated when a first user posts a request based on an item of collateral that is owned by the first user. The request can include photos of the collateral, a description of the collateral, a stated value of the collateral, a category of the collateral, and/or a proposed use of proceeds. Then, based, on the request, one or more computer systems (a desktop or laptop computer, a smartphone, a tablet, and so forth) of at least one second user who has selected to receive electronic notifications is instantly notified of the new request (e.g., via a push electronic notification, an SMS, and so forth). Based on the electronic notification, these computer system(s) display the request (including the photos, description, and so forth, provided by the first user), display a profile of the first user, and enable the second user(s) to respond to the request. For example, a second user may decline the request, or initiate an offer, using a user interface that is presented at the second user's computing device in response to the electronic notification. The a computer system of first user then receives electronic notifications associated with declined requests and/or offers. In the case of an offer, the first computer system can provide one or more options for the first user to accept the offer—which initiates a transaction with the second user, or the first user can reject the offer—which notifies the second user of such and terminates the second user's offer.

Once the first user has received approval, and the second user's resources have been certified by a central authority, the first user receives a shipping label for shipping the collateral to the central authority (e.g., for storage at a secure warehouse facility). The second user's computer system receives an electronic notification once the collateral has been shipped by the first user, as well as when the collateral has been received and inspected by the central authority. In response to the electronic notification that the collateral has been received and inspected by the central authority, the second user can choose to release resources to the first user (e.g., using a release option that is presented at the second user's computing device in response to the electronic notification).

Later, the first user's computing device receives an electronic notification of an upcoming agreement deadline. The first user can choose to meet the user's obligations of the agreement, in which case the collateral is shipped back to the first user and resources are transferred back to the second user. In some embodiments, the first user can choose to extend the agreement, which may result in extension penalties for the first user. In such embodiments, the agreement may be extended. If the first user misses an agreement deadline date, the collateral may be shipped to the second user.

In some embodiments, a score is created and maintained for users associated with the computing platform. In some embodiments, this score evolves into a type of “credit score” by accounting for a user's behavior over time. For example, when a user creates a profile and account, the computing platform capture attributes of the user (e.g., name, address, or other personally identifiable information). In some embodiments, data points like device ID may be linked to geographic location data to better identify the user and increase security (e.g., security flags may be triggered if an user's device ID is in one location, but the user then logs-in from a different location). In some embodiments, a user's performance on the platform over time may influence the user's score. As more and more performance data is gathered, the data feeding the score can alter the score, causing the score to age and stabilize.

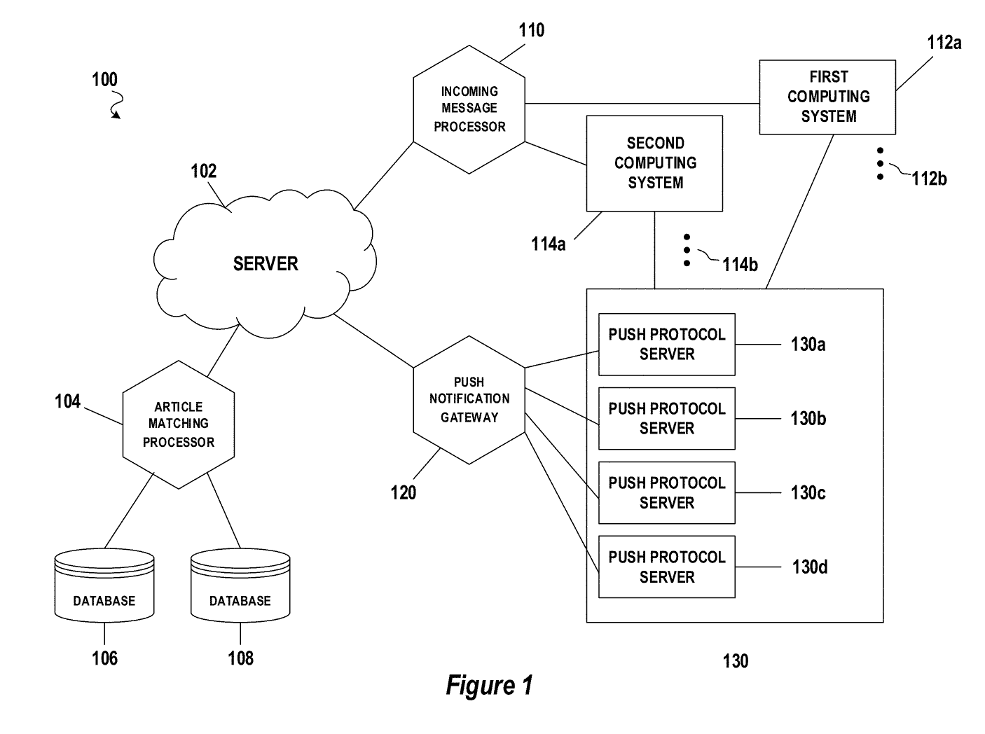

FIG. 1 illustrates a computing system 100 for implementing a computing platform consistent with the disclosure herein. Computing system 100 includes server 102, first computing systems 112, and second computing systems 114. Notably, while only one second computer system 114a and one first computer system 112a are shown, ellipses 114b and ellipses 112b represent that there may be any number of these computer systems. Server 102 includes or is associated with numerous subcomponents, including article matching processor 104, databases 106 and 108, incoming message processor 110, and push electronic notification gateway 120. Push electronic notification gateway 120 further includes push protocol discovery manager 130 including protocol servers 130a, 130b, 130c, and 130d.

In one embodiment, server 102 receives an incoming message from a first computing system 112 by way of incoming message processor 110 for initiating an agreement request. The incoming message includes information about an article a user of first computing system 112 would like to offer in exchange for a collateralized agreement. Included in that indication are one or more article identifiers, such as a photo, a description, an estimated value, an article type category, and/or a description of how the proceeds of a collateralized agreement will be used by the first user. Upon receipt of the message from first computer system 112, incoming message processor 110 may associate a unique identification and/or a score of the first user with the article identifiers, and store the foregoing in database 106.

At some point prior to this transaction, a second computing system 114 may have subscribed to electronic notifications from server 102 pertaining to any of a number of user-defined preferences associated with article identifiers, user identifiers, user scoring criteria, and so forth. Such preferences are stored in database 108, which may be separate from or integrated with database 106. Accordingly, once server 102 has received the incoming message from first computing system 112, processed the message through incoming message server 110, and stored the combined preferences in database 106, server 102 generates one or more electronic notifications of availability of the article that is being offered as collateral for one or more second computing systems 114. Server 102 may generate the one or more electronic notifications by accessing electronic notification preference database 108 to identify second user preferences, and then comparing the identified second user preferences to the articles and corresponding article identifiers associated with the first user that is stored in database 106. Server 102 may generate an electronic notification to send to any second computing system 114 that has been identified as having a preference that matches article identifiers, first user identifiers, and/or user scoring criteria.

Server 102 then sends one or more outgoing messages towards the second computing system(s) 114 by way of push electronic notification gateway 120. Prior to sending the electronic notification(s), gateway 120 utilizes push protocol discovery manager 130 to determine the appropriate push protocol to invoke based on characteristics derived from the particular second computing system 114. Once the proper push protocol has been determined, the corresponding push protocol server routes the electronic notification(s) in the corresponding protocol format to each applicable second computing system 114. Notably, the gateway 120, the discovery manager 130, and the protocol servers 130a, 130b, 130c, 130d may be individual components as illustrated in FIG. 1, or may otherwise be combined and/or merged into single multi-use computing system components or modules.

Once the proper protocols have been selected, and each outgoing message has been sent to a corresponding second computing system 114, each second computing system 114 that receives an electronic notification may display an interactive visual electronic notification that includes one or more options to view the offered article, to make an offer for a collateralized agreement against the article, and/or to reject the offer. In an embodiment in which a second user selects the option to make an offer for a collateralized agreement, the second computing system 114 sends a message to the server 102 including at least an offer for an amount of a collateralized agreement against the article.

Upon receipt of that message from the second computing system 114, the server 102 generates an outgoing message that includes the offer received from the second computing system 114, and sends that message to the first user's computing system 112. This may cause the first user's computing system 112 to display an interactive visual electronic notification which includes at least the option for the first user to accept or reject the offer made by the second user of the second computing system 114 that made the offer. Upon the user of first computing system 112 accepting or rejecting the offer, server 102 receives a message from the first computing system 112 that includes the first user's selection in response to the second interactive visual electronic notification (e.g., accepting or rejecting the offer made by the second user).

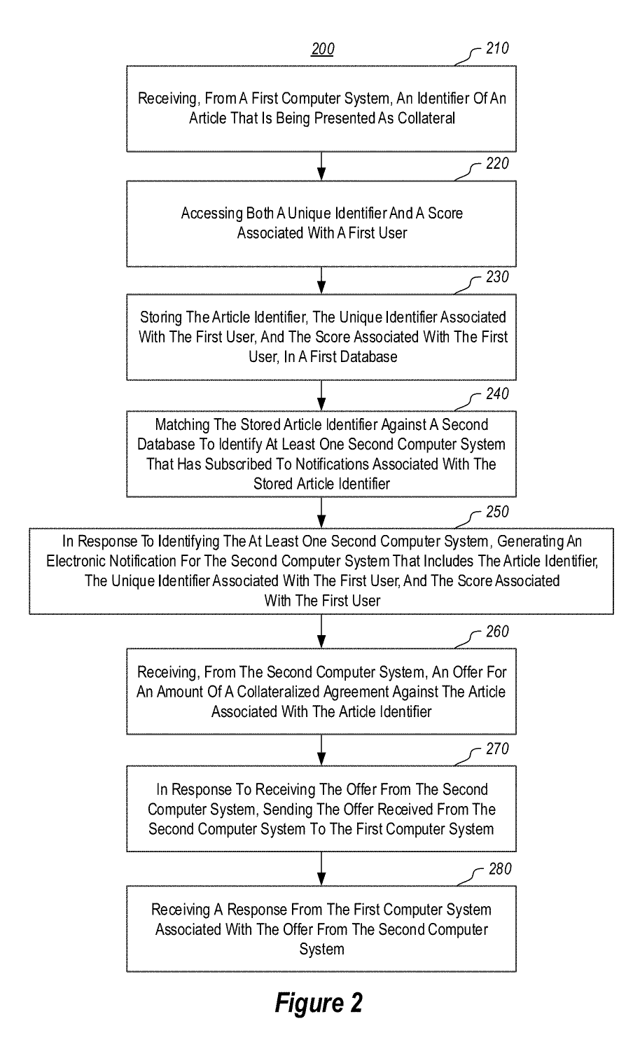

FIG. 2 shows a flow chart of a method 200 for utilizing interactive electronic push notifications to remotely facilitate collateralized arrangements. FIG. 2 is described with frequent reference to the computing system 100 of FIG. 1. The method 200 may include receiving, from a first computer system, an identifier of an article that is being offered as collateral (Act 210). Such article identifiers may include at least one of a photo, a description, an estimated value, a stated value, an article type category, or a description of proceeds use. In an example, the server 102 may receive an identifier (e.g., a photo) of an article being offered as collateral from the first computing system 112 for initiating an agreement request. The method 200 may also include accessing both a unique identifier and a score associated with a first user (Act 220). For instance, the server 102 may access a unique identifier and a score associated with the first user of the first computing system 112.

The method 200 may also include storing the article identifier, the unique identifier associated with the first user, and the score associated with the first user, in a first database (Act 230). For example, the server 102 can store information associated with both the first user, and the first user's request, in database 106. As such, the first database (e.g., the database 106) may include a plurality of article identifiers. The method 200 may further include matching the stored article identifier against a second database to identify at least one second computer system that has subscribed to notifications associated with the stored article identifier (Act 240).

For instance, the second database may include a one or more subscriptions from one or more second users, that each includes one or more subscriptions to electronic notifications associated with an availability of particular article identifiers stored in the first database. Accordingly, each second user may have a subscription, or preference, that matches the stored article identifier, and thus causes an electronic notification to be sent to the second user's computer system regarding the identifier associated with the article. Notably, such an electronic notification may comprise a short messaging service (SMS) message, a push electronic notification, an application generated prompt, a computer system prompt, and so forth.

The method 200 may also include, in response to identifying the at least one second computer system, generating an electronic notification for the second computer system that includes the article identifier, the unique identifier associated with the first user, and the score associated with the first user (Act 250). For instance, upon identifying a subscription/preference of a second user that matches the stored article identifier, the server 102 may generate an electronic notification for the second user's computer system (e.g., an electronic notification for the second computing system 114) that includes the article identifiers, the associated unique first user's identifier, and the associated score for the first user. Such an electronic notification may include at least one of an option to view the article, an option to make an offer for the article, or an option to reject the article. For instance, using the push electronic notification gateway 120, the server 102 can send an electronic notification to the first computing system 114 that includes at least one of the foregoing options (e.g., an option to view the article, to make an offer, and so forth).

The method 200 may also include receiving, from the second computer system, an offer for an amount of a collateralized agreement against the article associated with the article identifier (Act 260). For example, the server 102 may receive a message from the second computing system 114 that includes an offer for the article associated with the stored article identifier. The method 200 may further include, in response to receiving the offer from the second computer system, sending the offer received from the second computer system to the first computer system (Act 270).

For instance, the offer received from the second computer system that is sent to the first computer system may comprise an electronic notification that includes at least an option to accept or reject the offer from the second computing device. In an example, the server 102 can send a message to the first computing system 112, including the second user's offer. The method 200 may also include receiving a response from the first computer system associated with the offer from the second computer system. (Act 280). For instance, the server 102 can receive a message from the first computing system 112 that includes the first user's acceptance or rejection of the second user's request.

Reference herein has been made to a score associated with users. The scoring algorithm is a score that is designed to assess the quality of a user's profile who requests a collateral-backed agreement. In some embodiments, a user's score is updated with each transaction, accounting for the quality and performance of each transaction through time. The quality of the user's application, the quality of the collateral, and the user's historical performance (e.g., timely payments), will converge over time to allow the score to function more akin to a traditional credit score. As the score “ages,” it becomes a weighted credit score, where good performance with respect to payments and/or good performance in the posting of collateral appear as a normalized credit indicator.

In some embodiments, a score is tied to collateral quality, and the score incorporates the quality of the collateral a user posts. Quality, in this context, is measured in attribution and descriptors utilized by the user, not necessarily how “nice” an item is. In other embodiments, scores may incorporate a tangible substitute to collateral. In yet other embodiments, scoring also utilizes a “Know Your Customer” (KYC) factor, which creates a safer profile of users and helps alleviate fraud. By incorporating a “digital fingerprint” into the user's profile, the user is “known” to varying degrees (e.g., user's name and address match to public records, device ID, and so forth). Users may, in effect, get to “know” who another user is by their respective profile and the KYC data incorporated into the score. When a user executes a transaction or accesses the platform from a particular location, the user's score evolves. Additionally, these scores may capture any and all forms of identifying data at the personal and individual level, be it digital/social media, device ID, and so forth, that can be directly tied to an individual identifying them uniquely (whether singularly or through attribution and/or segmentation assignment.)

In some embodiments, KYC also includes attributes associated with each item posted as collateral for a collateralized agreement. This secondary KYC data includes attributes that are collected with each collateralized agreement request posting, in order to assess quality and completeness. Collateral description quality, photographs, and the level of posting precision, among other data points, each contribute to the score. Generally, a high-quality post in all measured forms raises the a user's score while a low-quality post lowers the user's score. In other embodiments, users are notified how to improve their score by adding/improving attributes of their post(s) and/or their personal information. In some embodiments, the score substitutes traditional collateral for other forms of tangible pledge or attribute(s) of value. The score can be recalibrated and leveled based on the alteration of a collateral backed input.

In some embodiments, a user's score can be computed by using the following equation:

STL=f((KYC₁,a-n)+(KYC₂,a-n)+History),

in which the score is a function of the sum of a first KYC₁ data point or set of data points scored on a range from “a-n,” a second KYC₂ data point or set of data points also scored on a range from “a-n,” and a metric capturing the “history” of the user being scored regarding performance (e.g., quality, reliability, and so forth)

For example, in one embodiment, a basic score is calculated when a user makes their first collateralized agreement request posting. With no user history, the model calculates the user's score as previously described. As collateral is received and transactions move through completion (e.g., payments are made and on time, communications are validated, and so forth), the user′ score is updated and becomes “refreshed.” Users are rated by one another to allow the scoring algorithms to capture positive and negative feedback. This methodology allows users to improve their score, graduating to improved ratings and ideally, improved borrowing rates (or, in the case of poor performing users, lowered borrowing rates.)

Thus, a user's score becomes a “credit score” for based on their activity within the computing platform and other data points, to help other users gauge each user's credit worthiness. This scoring enables users to actively improve their borrowing capabilities over time, by engaging in behaviors and providing information that improves their score. The scoring algorithm combines one or more of the following data and user behavior to establish credit worthiness: precise identification, profile accuracy and completeness, profile certification, historical performance, social connectivity validation, digital finger printing, and so forth. In some embodiments, determinations of scores may be performed independently from the computing platform and methodologies described herein. Thus, calculation and maintenance of scores may be performed by an entirely different entity and/or set of computer systems than the entity and/or set of computer systems providing collateralized agreements and purchasing.

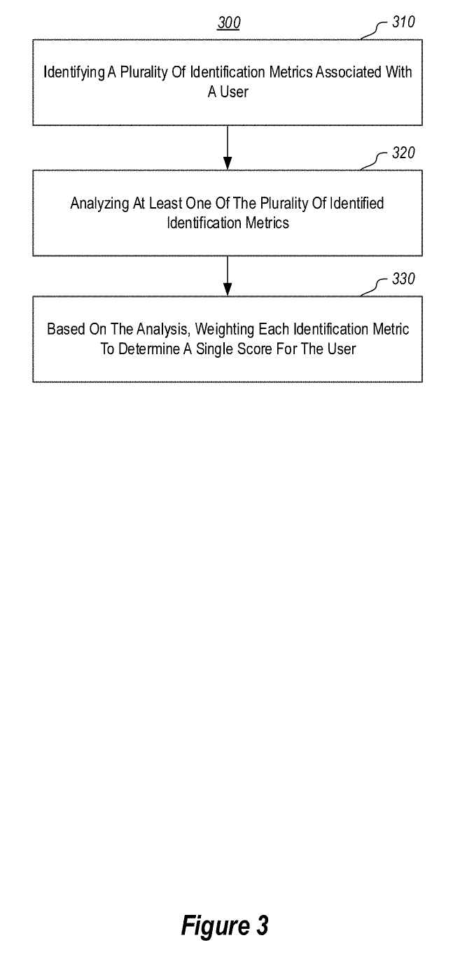

FIG. 3 illustrates a flowchart of a method 300 for determining a user's score. The method 300 includes identifying a plurality of identification metrics/factors associated with an user (Act 310). For instance, the server 102 may identify metrics such as precise identification, profile accuracy and completeness, profile certification, historical performance, social connectivity validation, digital finger printing, and so forth. The method 300 may also include analyzing at least one of the plurality of identified identification metrics (Act 320).

In an example, an score associated with a particular user may be at least partially determined based on the accuracy of provided profile information by utilizing cross-referenced public records and connections to data provided by third party identification providers. A score may also be determined based on user profile completeness. A score may further be determined based on profile information accuracy, which can be verified by contacting independent references. A score may also be determined based on prior participation and payment history. A score may further be determined based on whether the user's account details are validated against external data parsed from the user's connected social media, such as Facebook®, LinkedIn® and Twitter®, using application authentication and direct connect application programming interfaces (API's). A score may also be based on digital finger-printing data points that include one or more of a device identifier, geo-location data, triangulation data, and connectivity data. Notably, while each of the metrics enumerated are described separately, any combination of the described metrics may be used in a determination of a score associated with a particular user.

The method 300 may also include, based on the analysis, weighting each metric to determine a single score for the particular user (Act 330). Accordingly, once one or more of the metrics have been considered, each factor may be individually weighted to produce a final score for the particular user. In some embodiments, each metric may be given even weighting. In other embodiments, the individual score weighting may be about 25% for a precise identification metric, about 25% for a profile accuracy and completeness metric, about 25% for a profile certification metric, about 20% for a performance metric, and about 5% for a social connect metric. In yet other embodiments, the weighting of metrics may be dynamic, such that metrics may weighted differently at different times based on a determined relevance of a given metric at any given point in time. It should be appreciated that other scoring metrics may be included or some scoring factors may be omitted. Further, the particular weighting given to a particular score may vary over time. For instance, in some embodiments, as a user has a longer history, a history factor may gain greater relative weight at the consequence of lowering the weighting of other factors.

Notably, scores may be recalculated periodically for any number of reasons. For instance, scores may be recalculated at determined intervals. In a more specific example, scores may be recalculated once a month, quarterly, once a year, and so forth. In another example, scores may be recalculated when a change associated with one or more of the identification factors/metrics has been detected. In a more specific example, recalculation of scores may occur when a change is identified in one or more of profile information accuracy, user profile completeness, prior participation and payment history, validation of account details against external data parsed from a user's connected social media, or digital finger-printing data points of a given user.

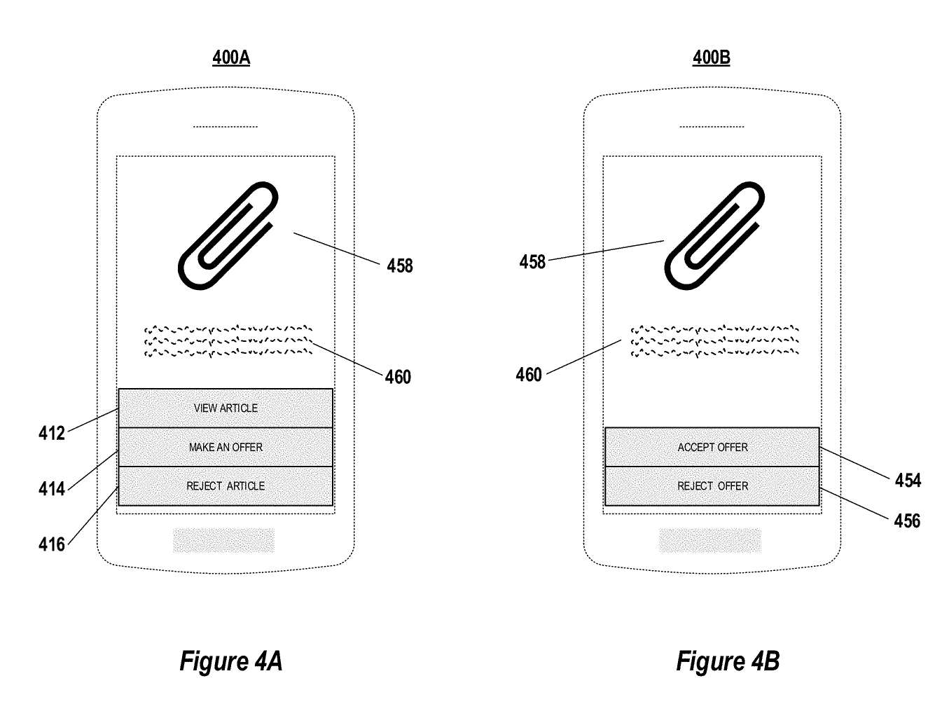

FIGS. 4A and 4B illustrate embodiments of interactive visual electronic notifications received at the first and second computing systems. The interactive visual displays include two computing devices, computing device 400A and computing device 400B. The computing devices may comprise a desktop computer, laptop computer, mobile phone, tablet, smart watch, and so forth. As discussed in conjunction with FIG. 1, upon finding a match between any of a number of identifiers of a corresponding article, and a set of electronic notification preferences, one or more electronic notifications of availability of the article offered as collateral is generated.

The electronic notification is then sent toward a computing system of a potentially interested user and, upon receipt by that user's computing system (e.g., device 400A), causes an interactive visual display to be shown on the device 400A. The interactive visual display shown on device 400A may include any of an article photo 458, and article description 460, and a series of selectable options including options to “View Article” 412, “Make an Offer” 414, and “Reject Article” 416. The user of device 400A may execute any of options 412, 414, and 416 by utilizing the interface of the particular computing device and selecting the option. In each case, selecting an option will cause a communication to be generated between the computing device and a remote server as discussed in FIG. 1. In the embodiment illustrated in FIGS. 4A and 4B, the user of device 400A has selected the “Make an Offer” option 414. In some embodiments, this single selection will cause a pre-determined offer to be sent, by means of the remote server, to computing device 400B of another user.

Upon receipt of the electronic notification at computing device 400B, article photo 458 and article description 460 are displayed along with selectable options “Accept Offer” 454 and “Reject Offer” 456. As with the selectable options displayed on device 400A, selectable objects 454 and 456 are configured to instantiate particular communications with a remote server including transmitting the selected indication. In the example embodiment of FIGS. 4A and 4B, the “Accept Offer” 454 option has been selected. Upon selection of that option, the remote server will receive an incoming message from computing system 400B including the user's selection.

It should be appreciated that the illustrations of FIGS. 4A and 4B do not limit the interactive visual displays to only the configurations shown. Interface elements, arrangement, and interaction capabilities may vary based on the capabilities of the devices represented as devices 400A and 400B. Additionally, some information like article photo 458 may be omitted to better support varying screen configurations while maintaining functionality of interactive elements 412, 414, 416, 454, and 456.

In this way, a computing platform allows for directly connecting first users having items to offer as collateral with second users who are willing to provide resources against the items of collateral (and to take possession of the collateral, should a first user fail to meet collateralized agreement obligations). The computing platform described herein employs unique subscription mechanisms to enable potential second users to subscribe to electronic notifications of the availability of particular goods, and unique electronic notification mechanisms to notify the potential second users when a first user seeks resources against a subscribed-to good. Doing so achieves improved computing efficiency over existing online storefronts, by at least eliminating a great number of search queries associated with the availability of goods.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, implemented at a computer system that includes one or more processors, for utilizing interactive electronic push notifications to remotely facilitate collateralized arrangements, the method comprising:
receiving, from a first computer system, an identifier of an article that is being offered as collateral;
in response to receiving the article identifier, performing at least the following:
accessing both a unique identifier and a score associated with a first user;
storing the article identifier, the unique identifier associated with the first user, and the score associated with the first user, in a first database;
matching the stored article identifier against a second database to identify at least one second computer system that has subscribed to notifications associated with the stored article identifier;
in response to identifying the at least one second computer system, generating an electronic notification for the second computer system that includes the article identifier, the unique identifier associated with the first user, and the score associated with the first user;
receiving, from the second computer system, an offer against the article associated with the article identifier;
in response to receiving the offer from the second computer system, sending the offer received from the second computer system to the first computer system; and
receiving a response from the first computer system associated with the offer from the second computer system.

2. The method of claim 1, wherein the article identifier includes at least one of a photo, a description, an estimated value, an article type category, or a description of proceeds use.

3. The method of claim 1, wherein the first database includes a plurality of article identifiers.

4. The method of claim 1, wherein the second database includes a plurality of second computer system subscriptions, each including one or more subscriptions to electronic notifications associated with an availability of particular article identifiers stored in the first database.

5. The method of claim 1, wherein the electronic notification comprises at least one of a SMS, a push electronic notification, an application generated prompt, or a computer system prompt.

6. The method of claim 1, wherein the score includes one or more identification metrics, including at least one of a precise identification metric, a profile accuracy metric, a profile completeness metric, a profile certification metric, a performance metric, or a social connect metric.

7. The method of claim 6, wherein each of the at least one identification metrics is given equal weight in determining the score.

8. The method of claim 6, wherein each of the at least one identification metrics is given differing weights when determining the score.

9. The method of claim 1, wherein the score is recalculated for the first user at a determined interval.

10. The method of claim 6, wherein the score is recalculated when a change associated with one or more of the at least one identification metric is detected.

11. A computer system, comprising:
one or more processors; and
one or more computer-readable media having stored thereon computer-executable instructions that are executable by the one or more processors to cause the computer system to utilize interactive push electronic notifications to remotely facilitate collateralized arrangements, the computer-executable instructions including instructions that are executable to cause the computer system to perform at least the following:
receive, from a first computer system, an identifier of an article that is being offered as collateral;
in response to receiving the article identifier, perform at least the following:
accessing both a unique identifier and a score associated with a first user;
storing the article identifier, the unique identifier associated with the first user, and the score associated with the first user, in a first database;
matching the stored article identifier against a second database to identify at least one second computer system that has subscribed to notifications associated with the stored article identifier;
in response to identifying the at least one second computer system, generating an electronic notification for the second computer system that includes the article identifier, the unique identifier associated with the first user, and the score associated with the first user;
receiving, from the second computer system, an offer against the article associated with the article identifier;
in response to receiving the offer from the second computer system, sending the offer received from the second computer system to the first computer system; and
receiving a response from the first computer system associated with the offer from the second computer system.

12. The computer system of claim 11, wherein the article identifier includes at least one of a photo, a description, an estimated value, an article type category, or a description of proceeds use.

13. The computer system of claim 11, wherein the first database includes a plurality of article identifiers.

14. The computer system of claim 11, wherein the electronic notification is configured to cause a first interactive visual electronic notification to be generated at the second computer system, the interactive visual electronic notification including at least an option to view the article, make an offer for the article, or reject the article.

15. The computer system of claim 14, wherein the offer is generated by the second computer system in response to the interactive visual electronic notification.

16. The computer system of claim 11, wherein sending the offer received from the second computer system comprises causing an interactive visual electronic notification to be generated at the first computer system, the interactive visual electronic notification including at least an option to accept or reject the offer from the second computing device.

17. The computer system of claim 11, wherein the score includes one or more identification metrics, including at least one of a precise identification metric, a profile accuracy metric, a profile completeness metric, a profile certification metric, a performance metric, or a social connect metric.

18. The computer system of claim 17, wherein each of the at least one identification metrics is given differing weights when determining the score.

19. The computer system of claim 11, wherein the score is recalculated for the first user at a determined interval.

20. A computer program product comprising one or more hardware storage devices having stored thereon computer-executable instructions that are executable by one or more processors of a computer system to cause the computer system to utilize interactive push electronic notifications to remotely facilitate collateralized arrangements, the computer-executable instructions including instructions that are executable to cause the computer system to perform at least the following:
receive, from a first computer system, an identifier of an article that is being offered as collateral;
in response to receiving the article identifier, perform at least the following:
accessing both a unique identifier and a score associated with a first user;
storing the article identifier, the unique identifier associated with the first user, and the score associated with the first user, in a first database;
matching the stored article identifier against a second database to identify at least one second computer system that has subscribed to notifications associated with the stored article identifier;
in response to identifying the at least one second computer system, generating an electronic notification for the second computer system that includes the article identifier, the unique identifier associated with the first user, and the score associated with the first user;
receiving, from the second computer system, an offer against the article associated with the article identifier;
in response to receiving the offer from the second computer system, sending the offer received from the second computer system to the first computer system; and
receiving a response from the first computer system associated with the offer from the second computer system.
